(19) United States
(12) Patent Application Publication
(10) Pub. No.: US 2019/0176119 A1
(43) Pub. Date: Jun. 13, 2019

(54) SYSTEM FOR DISTRIBUTING A LIQUID AND/OR GAS PHASE INTO A REACTION VESSEL

(71) Applicant: AXENS, Rueil-Malmaison Cedex (FR)

(72) Inventors: Etienne NIDERKORN, RUEIL MALMAISON (FR); Jauffroy DELTEIL, MOISSELLES (FR); Daniel-Jean VINEL, LES MUREAUX (FR)

(21) Appl. No.: 16/214,219

(22) Filed: Dec. 10, 2018

(30) Foreign Application Priority Data
Dec. 11, 2017 (FR) 17/61.897

(51) Int. Cl. B01J 8/02; B01J 8/18; B01J 8/04

(52) U.S. Cl. CPC B01J 8/0278; B01J 8/008; B01J 8/0492; B01J 8/1827

(57) ABSTRACT

System for distributing a liquid and/or gas phase into a reaction vessel (1g), reaction vessel (1g) comprising at least one inlet (1h) for injection of the liquid and/or gas phase, the system according to the invention comprising a distributor for distributing this phase by means of at least one tube (1d) provided with a plurality of perforations (2d), as well as removable fastening means (1i) for the distributor when it is arranged within the reaction vessel. According to the invention, the section of the distributor is smaller than the section of inlet (1h) of reaction vessel (1g), so as to be able to insert and/or to remove the distributor through inlet (1h) of vessel (1g).

Application to the field of petroleum refining, more particularly to the distribution of a liquid and/or gas phase into a reaction vessel.

FIG. 2.1 to be published.

### FIELD OF THE INVENTION

The present invention relates to the field of petroleum refining, and more precisely to the distribution of a liquid and/or gas phase into a reaction vessel.

More particularly, the present invention can concern a two-phase reactor one of whose reactants is injected in gas or liquid phase into any medium (gaseous, liquid or solid, or a mixture thereof), preferably a fouling solid or liquid medium, such as for example in the case of homogeneous catalysis reactors implemented for alpha-olefin production methods using limited ethylene polymerization (dimerization, trimerization or tetramerization).

Indeed, limited polymerization can lead to the formation of by-products in small amounts (such as polyethylenes), which may accumulate in the reaction medium, deposit on all the internals and cause fouling of the distributor in particular. The distributor needs to be regularly removed for washing and put back in place thereafter.

By way of example, one may consider the AlphaButol® process wherein the distributor injects into a liquid reaction medium (essentially made up of Butene-1 at its bubble point) either ethylene alone, or a liquid hydrocarbon under reaction conditions (Butene-1, iso Pentane, Hexane, cyclohexane for example), or a mixed phase consisting of ethylene (gas) and of a liquid hydrocarbon under reaction conditions (Butene-1, iso Pentane, Hexane, cyclohexane for example). It is thus a gas, liquid or gas plus liquid distributor. The distributor used needs to be frequently cleaned, which requires closing down the unit upon removal/reinstallation of the distributor. It is therefore necessary to facilitate this intervention as much as possible so as to limit the duration thereof and the inherent production loss. Furthermore, in the case of the AlphaButol process, the liquid reaction medium is perfectly stirred by means of one or more repumping loops (loop flow) whose flow rate is maximized. Due to its nature (mainly gas injection into a liquid), and as it is additionally subjected to this very high loop flow rate, the distributor undergoes high mechanical and vibratory stresses. It is therefore necessary for a distributor intended to supply a liquid and/or gas phase, at least for this type of process with high mechanical and vibratory stresses, to be perfectly supported in its operating position.

Furthermore, for homogeneous catalysis processes, oxygen and the ambient air humidity are known poisons. It is therefore essential to limit as much as possible air inflows towards the reactors, and a fortiori outward openings (such as manholes, hand holes). It is thus important to limit these openings to the outside.

### BACKGROUND OF THE INVENTION

Patent application US-2012/0,321,529 for example describes a distributor in form of circular plates comprising holes. In this document, the distributor is permanently secured to the wall of the reaction vessel. Indeed, considering the reaction involved (oxidation of gas-phase ammonia), it is not necessary to clean this distributor.

Patent application WO-2017/003,643 describes separate gas and liquid distributors arranged above one another. In this document, the distributors are permanently attached through the agency of a main pipe running through the reactor wall and opening onto perforated tubes. Indeed, the reaction involved (injection of gaseous oxygen into a liquid containing cyclohexylbenzene and a soluble organic catalyst (imide)) does not require cleaning the distributor.

Furthermore, document U.S. Pat. No. 4,198,210 describes a distributor consisting of tubes lined with a refractory material, welded together and to the reaction vessel. The tubes are reinforced so as to withstand the erosion that occurs upon gasification of the fluidized coal in a liquid phase. This type of distributor runs through the reactor wall and it is permanently secured to this wall because it is not necessary to clean this type of distributor.

Finally, document US-2005/0,209,351 describes a gas distributor in a phase both liquid and solid (referred to as slurry phase), comprising rings or rods provided with a multitude of perforations, and possibly nozzles for injecting gas. In this case, in order to prevent clogging of the perforations provided in the distributor, a perforated plate is arranged above said distributor whose holes are small enough to prevent passage of catalyst grains likely to clog the holes. It is therefore not necessary to remove the distributor from the reaction vessel to which it is attached.

Thus, none of the prior art documents describes a distributor that can be readily removed from the reactor in order to be cleaned, then easily put back in its operating position, without requiring intervention inside the reactor. Now, this is particularly advantageous in cases where the distributor is operating in a fouling environment. The distributor according to the invention overcomes these drawbacks. The distributor according to the invention can be used for injecting either gas or liquid, or a mixture thereof.

### SUMMARY OF THE INVENTION

The present invention relates to a system for distributing a liquid and/or gas phase into a reaction vessel, said vessel comprising at least one inlet for an injection of said phase. The system according to the invention comprises:
a distributor for distributing said phase, comprising at least one tube, said tube including a plurality of perforations,
means for removable fastening of said distributor when it is arranged in the inlet of said vessel.

Furthermore, according to the invention, the section of at least said distributor is smaller than the section of said inlet.

According to an implementation of the invention, said removable fastening means can consist of an assembly for reversibly securing at least one of the ends of said distributor to said inlet of said vessel.

Advantageously, said assembly can comprise at least one flange, a seal and at least one screwed joint.

According to a variant of the invention, said system can further comprise means for supporting said distributor at least at one point of said vessel opposite said inlet of said vessel.

Advantageously, said support means can comprise a rail intended to be fastened along said tube of said distributor, two plates intended to be fastened vertically onto a wall of said vessel so as to receive and hold said rail, the section of the assembly made up of at least said distributor and said rail being smaller than the section of said inlet of said vessel.

Alternatively or additionally, said support means can comprise a gutter and a support for said gutter, said gutter and said support being intended to be secured to said reaction vessel so as to allow said distributor to slide and to be kept in line with said inlet.

According to another design of the invention, said support means can comprise a circular arc-shaped part intended to be fastened to the wall of said reaction vessel and to allow said distributor to be kept in line with said inlet.

According to another variant of the invention, said system can comprise means for guiding said distributor upon its insertion into and/or removal from said vessel, the section of the assembly made up of at least said distributor and said guide means arranged on said distributor being smaller than the section of the inlet of said vessel.

Advantageously, said guide means can comprise a plurality of fins distributed in a longitudinal direction over said tube of said distributor so as to provide centering of said distributor upon its insertion into and/or removal from the inlet of said vessel.

Furthermore, said system can comprise means for installing said distributor in said vessel, said installation means being intended to be arranged outside said vessel.

According to a first design of the invention, said means for installing said distributor can comprise a movable platform whose deck is at the height of said inlet of said vessel.

According to a second design of the invention, said installation means can comprise a rail, a pulley system and a counterweight.

The invention also relates to a reaction vessel comprising at least one system for distribution of a liquid and/or gas phase as described above.

The invention further relates to a use of a reaction vessel comprising at least one system for distribution of a liquid and/or gas phase as described above for a petroleum refining process.

According to an implementation of the invention, said refining process is a limited polymerization process.

### BRIEF DESCRIPTION OF THE FIGURES

Other features and advantages of the system according to the invention will be clear from reading the description hereafter of embodiments given by way of non limitative example, with reference to the accompanying figures wherein:

FIG. 1 illustrates an example of a reaction vessel provided with a liquid and/or gas phase distribution system according to the invention,

FIG. 2.1 corresponds to a cross-sectional view of a system intended for distribution of a phase according to an implementation of the invention, when the distributor is in operating position in a reaction vessel,

FIG. 2.2 corresponds to a front view of the system shown in FIG. 2.1, seen from the side of the reaction vessel inlet,

FIG. 2.3 corresponds to a front view of the system shown in FIG. 2.1, seen from the point opposite the reaction vessel inlet,

FIG. 2.4 corresponds to a partial top view of the system shown in FIG. 2.1, seen from the point opposite the reaction vessel inlet,

FIG. 3.1 corresponds to a cross-sectional view of a system intended for distribution of a phase according to another implementation of the invention,

FIG. 3.2 corresponds to a front view of the system shown in FIG. 3.1, seen from the side of the reaction vessel inlet when the distributor is inserted in the flange of the enclosure,

FIG. 3.3 corresponds to a front view of the system shown in FIG. 3.1, seen from the point opposite the reaction vessel inlet, and

FIG. 3.4 corresponds to a partial top view of the system shown in FIG. 3.1, seen from the point opposite the reaction vessel inlet.

### DETAILED DESCRIPTION OF THE SYSTEM

In general terms, one object of the invention relates to a system for distributing a liquid and/or gas phase into a reaction vessel, comprising a distributor for distributing the phase considered. Conventionally, the reaction vessel, also referred to as enclosure, in which the distributor according to the invention is to be arranged comprises at least one inlet for the phase to be distributed by the distributor according to the invention. The distributor according to the invention is intended to cooperate with the inlet located in the reaction vessel for injection of the liquid and/or gas phase. Conventionally, the inlet of the reaction vessel for injection of the gas or liquid phase to be distributed comes in form of a pipe arranged next to a wall, preferably vertical, of the reaction vessel. Conventionally, the reaction vessel can have a cylindrical shape with a semi-hemispherical, hemispherical or flat bottom.

According to the invention, the liquid and/or gas phase distribution system comprises at least one distributor in form of a tube and means for removably fastening the distributor when it is arranged in the reaction vessel. According to the invention, the distributor removable fastening means allow the distributor to be held and fastened in operating position in the reaction vessel, while enabling removal thereof, notably for maintenance purposes. According to the invention, the section of the distributor at least is smaller than the section of the inlet arranged in the vessel for injecting the phase considered. It is thus possible for the distributor to be inserted into and/or removed from the reaction vessel by passing it through the inlet of the reaction vessel for injection of the phase. Thus, in combination with the means for removably fastening the distributor in the reaction vessel, it is possible for the distributor according to the invention to be inserted and/or removed through the inlet provided in the reaction vessel for injection of the liquid and/or gas phase. Thus, removal and installation of the distributor in the reaction vessel requires no manhole or hand hole.

According to an implementation of the invention, the diameter of the tube of the distributor according to the invention preferably ranges between 30 mm and 600 mm, more preferably between 50 mm and 400 mm, and according to the invention this diameter is smaller than that of the inlet pipe of the reaction vessel. Thus, notably upon removal of the distributor when it is clogged with polymerization by-products such as polyethylenes forming a layer on the distributor, the risk of these by-products falling off the distributor as it passes through the inlet pipe of the reaction vessel and falling in the bottom of the reaction vessel, thus contributing to fouling of the reaction vessel, is therefore reduced.

According to another implementation of the invention, the distributor is a multi-branch distributor. According to a variant of this implementation, the distributor comprises a main tube divided into a bundle of secondary tubes, perforated, of smaller diameter than the main tube. According to another variant of this implementation, the distributor comprises a main tube and a plurality of secondary tubes, perforated, of smaller diameter than the main tube, provided at a non-zero angle on the outer face of the main tube. According to the invention, the largest dimension of the assembly made up of the main tube and its secondary tubes cannot exceed the diameter of the inlet pipe, so as to be able to insert and/or remove the distributor through this inlet.

According to the invention, the tube of the distributor comprises a plurality of perforations, these perforations being intended for passage of the phase to be injected into the reaction vessel by the distributor. According to an implementation of the invention, the perforations are randomly provided on the distributor tube. According to another implementation of the invention, the perforations are distributed along a helix provided along the distributor tube. According to another alternative implementation of the invention, the perforations are distributed along a plurality of equidistant circles provided along the distributor tube. According to a preferred implementation of the invention, the perforations can be provided along one or more lines in a longitudinal direction of the tube, and the perforations can be directed downward, laterally or upward of the distributor. According to another preferred implementation of the invention, the perforations are distributed along the intersections with the tube of two planes passing through the distributor axis and forming a 60° angle between them. Advantageously, a marking exterior to the distributor allows the position of the perforations to be indicated.

According to an implementation of the invention, the distributor tube is provided at one end thereof with a removable end cap (bolted, screwed or clipped for example) whose section is smaller than the diameter of the phase injection inlet provided in the reaction vessel. Preferably, the removable end cap has a polygonal, hexagonal, triangular or square shape. The distributor can thus be installed in and/or removed from the reaction vessel through the inlet pipe of the reaction vessel, and possible catch points for the polymeric by-products forming a layer on the distributor tube can be limited.

According to a first variant implementation of the invention, the means for removably fastening the distributor consist of an assembly for reversibly securing at least one end of the distributor to the inlet pipe of the reaction vessel. According to an implementation of the invention, this assembly for fastening the distributor to the reaction vessel inlet comprises at least one flange, a seal and at least one screwed joint. According to this first variant implementation of the invention, the other end of the distributor comprises no means for removably fastening the distributor. Such a variant can be used in cases where the mechanical and vibratory stresses are limited (for small-size distributors for example).

According to a second variant implementation of the invention, the system according to the invention comprises, in addition to the removable fastening means as described above in the first variant implementation (i.e. removable fastening means intended to reversibly fasten a single end of the distributor tube), distributor support means, the support means being intended to hold the distributor in the operating position thereof. Such a variant implementation of the invention is pertinent in cases where it is important to keep the distributor in line, for example in case of moderate to high mechanical and vibratory stresses. Such a variant implementation of the invention is pertinent in cases where it is necessary to keep the distributor in line, for example in case of moderate to high mechanical and vibratory stresses. Such a variant implementation of the invention makes it possible not to require removable fastening means at both ends of the tube, while keeping the tube in operation.

According to a first embodiment of this second variant implementation of the invention, the distributor support means consist of an element intended to be attached at a point of the reaction vessel opposite the reaction vessel inlet. Preferably, the distributor support means are fastened at a point of the reaction vessel wall and they can consist of any means known to the person skilled in the art for supporting the end of the distributor, such as, for example, a short arc of a circle, or two V-shaped plate pieces, or a T-shaped support plate. Preferably, the support means are made of metal. According to an implementation of the invention, the support means are directly welded at a point of the enclosure wall. According to another implementation of the invention, the support means consist of a short arc of a circle intended to be arranged in a pipe of the distributor provided opposite the inlet pipe intended for injection of the phase to be distributed. For this particular implementation mode, the shape of the arc of a circle matches that of this second pipe and it allows the distributor to be kept along an axis passing through the reaction vessel inlet.

According to a second embodiment of this second variant implementation of the invention, the support means of the distributor according to the invention comprise at least one rail intended to be fastened along a tube of the distributor and at least two plates intended to be vertically fastened to the reaction vessel wall, so spaced out as to receive and hold the rail. Such an implementation mode of the invention is pertinent in case of moderate mechanical and vibratory stresses that do not require maintaining the distributor strongly in place at a point opposite the inlet. The section of the assembly made up of the tube and the rail needs to be smaller than the section of the inlet pipe of the reaction vessel so that, during installation and/or removal operations, this assembly can be inserted and/or removed through the inlet provided in the enclosure. The rail can be removably fastened to a distributor tube so as to facilitate cleaning thereof and of the tube it is fastened to. Alternatively, the rail can be fastened to the tube by welding. According to an embodiment of the invention wherein the distributor is a multi-branch distributor in form of a bundle of secondary tubes, the support means according to the invention can comprise a plurality of rails intended to support at least one sub-assembly of secondary tubes of the distributor. According to an embodiment of the invention where the distributor is a multi-branch distributor in form of a main tube comprising, on the outer face thereof, a plurality of secondary tubes forming a non-zero angle with the main tube, the support means according to the invention can comprise a rail intended to support the main tube of the distributor.

According to a third embodiment of this second variant implementation of the invention, the support means of the distributor according to the invention comprise a gutter and at least one support for this gutter, so that the distributor tube rests on this gutter when it is in operating position in the reaction vessel. Such an implementation mode of the invention is pertinent in case of moderate to high mechanical and vibratory stresses requiring support all along the distributor. Furthermore, the gutter also allows the tube to be guided, through sliding, upon installation in and/or removal from the reaction vessel. According to an implementation of the invention, one end of the gutter lies in the inlet pipe, the other end resting on a gutter support fastened at a point of the reaction vessel opposite the inlet. According to an implementation of the invention, the gutter is fastened to the gutter support by screwing means.

According to a fourth embodiment of this second variant implementation of the invention, the second and third embodiments of this second variant implementation of the invention are combined. According to this fourth embodiment, the support means can for example comprise a rail intended to be fastened along the distributor tube, as well as a gutter whose section makes it possible for the assembly made up of the tube and the rail to rest and slide in the gutter. According to this fourth embodiment, the gutter can come in form of a single piece or of two pieces.

According to a third variant implementation of the invention that can be combined with the first and/or second variants described above, the distributor according to the invention further comprises guide means intended to facilitate centering of the distributor with respect to its final axis and positioning thereof upon installation in the reaction vessel. Thus, when the removable fastening means comprise flanges as described above, the guide means according to the invention can notably be designed to position the flange of the distributor perfectly in line with the flange of the reaction vessel, so as to provide perfect sealing of the assembly after fastening, preferably by bolting. According to an implementation of the invention, when they are combined with the second and third variants described above, the guide means further allow the distributor to be readily positioned in its final holding point, which is at least at one point opposite the phase injection vessel inlet.

According to a first embodiment of this third variant implementation of the invention that can be combined with any one of the variants described above, the guide means comprise a plurality of fins positioned on the distributor, and the section of the assembly made up of the fins and the distributor tube needs to be smaller than the section of the reaction vessel inlet pipe. Preferably, at least two fins are arranged on the tube of the distributor according to the invention, more preferably between 2 and 5 fins, and more preferably yet between 2 and 8 fins. Advantageously, in cases where the support means according to the invention comprise a gutter and a single gutter support, the gutter also comprises at least one fin in its part intended to be arranged in the inlet pipe, so as to contribute to centering of the distributor along the final axis thereof.

According to a fourth variant implementation of the invention that can be indifferently combined with the first and/or second and/or third variant implementation of the invention, the phase distribution system according to the invention comprises means for installing the distributor in the reaction vessel, intended to be arranged outside the vessel.

According to a first implementation of this fourth variant of the invention, the distributor installation means comprise a movable platform whose deck is at the height of the inlet pipe of the vessel. Advantageously, the deck comprises a ball bearing system enabling sliding of the distributor in the pipe.

According to a second implementation of this fourth variant of the invention, the distributor installation means comprise an outer rail, a counterweight and a pulley system or any equivalent. According to this implementation, the distributor is engaged along the outer rail and the pulley system plus the counterweight allows the assembly to be held at the height of the reaction vessel inlet.

Furthermore, the present invention relates to a reaction vessel comprising at least one distributor according to any of the variant combinations described above.

The distributor can be arranged in the bottom of the vessel for feeding a fluid into the vessel.

According to an aspect of the invention, the vessel can comprise a plurality of tubular distributors. These distributors can be arranged parallel to one another at the same height relative to the vessel, or at a different height. This configuration allows the homogeneity of distribution in the vessel to be improved.

Besides, the invention relates to the use of such a vessel for a petroleum refining process, notably a limited polymerization process.

In particular, the vessel can be used for an AlphaButol® process wherein the distributor injects into a liquid reaction medium (essentially made up of Butene-1 at its bubble point) either ethylene alone, or a liquid hydrocarbon under reaction conditions (Butene-1, iso Pentane, Hexane, cyclohexane for example), or a mixed phase consisting of ethylene (gas) and of a liquid hydrocarbon under reaction conditions (Butene-1, iso Pentane, Hexane, cyclohexane for example). The design of the distributor according to the invention allows simple removal and installation, and therefore easier cleaning and/or maintenance.

### Example Embodiment

The features and advantages of the system according to the invention will be clear from reading the example embodiment described below.

FIG. 1 shows a non-limitative arrangement of a reaction vessel 1g corresponding, by way of illustration, to a limited polymerization reactor, provided with a distributor 1d according to the invention. This reaction vessel also comprises an outlet 1a for discharge of a gas phase (optionally shown here on a manhole), an outlet 1b for discharge of the gaseous or mixed effluent, a liquid inlet 1c (that can be provided with a specific distributor), the liquid level in the vessel being represented by dotted line L, a liquid outlet 1e (that can also be arranged below the weld line of the enclosure bottom, below the tangent line TL) that can be substituted with drain 1f (which can be used as a liquid outlet and be provided with an anti-vortex device).

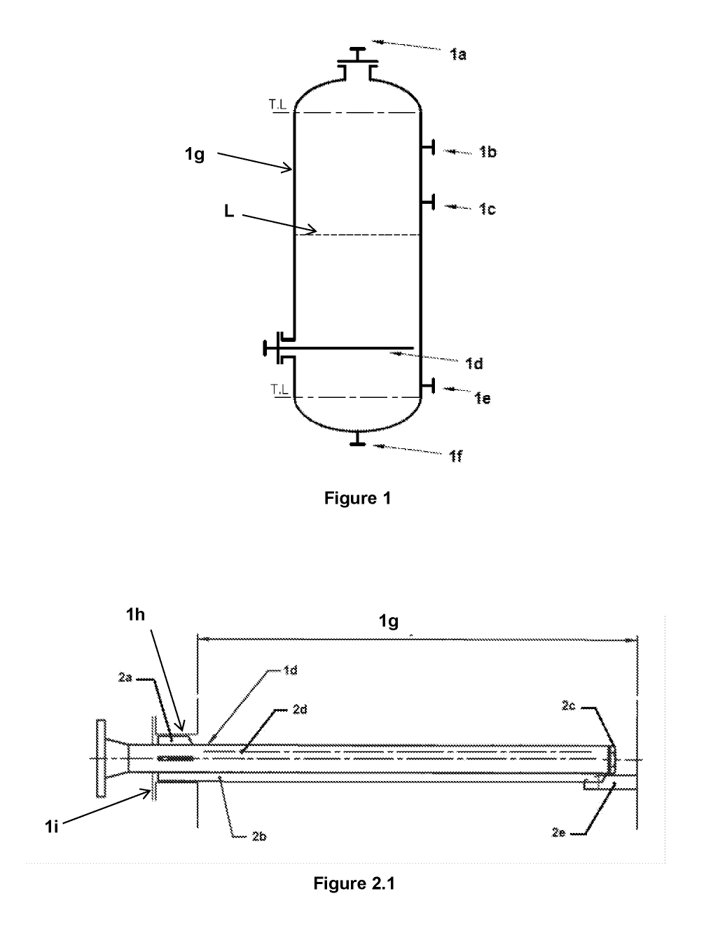

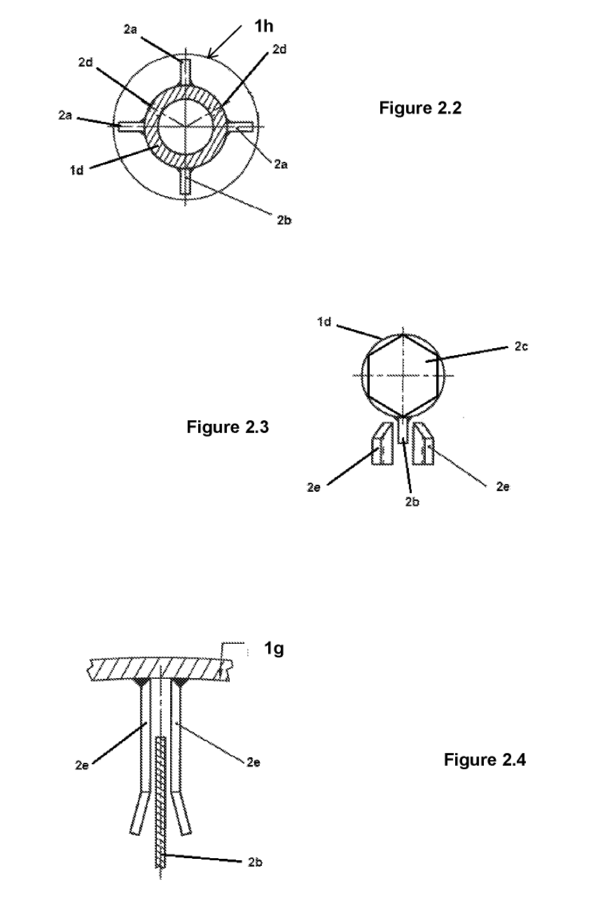

FIG. 2.1 shows in detail a non-limitative example of a system for distribution of a phase according to the invention, comprising a distributor 1d in form of a tube, provided with perforations 2d, removable fastening means 1i, support means in form of a rail 2b and of two plates 2e for fastening and holding rail 2b, guide means in form of fins 2a and a removable end cap 2c of hexagonal shape. In this figure, the phase distribution system according to the invention is in operating position in reaction vessel 1g comprising an inlet for phase 1h in form of a pipe. According to this design of the invention, rail 2b corresponds to a simple rod running along the distributor. Support rail 2b cooperates with two pieces 2e directly welded to the wall of the enclosure and so arranged that rail 2b fits perfectly, as shown in FIGS. 2.3 and 2.4. According to this design of the invention, and as detailed in particular in FIGS. 2.1 and 2.2, fins 2a and rail 2b allow the tube to be centered in the inlet for phase 1h. Upon installation thereof, the distributor according to this design of the invention can thus be easily positioned simply by pushing thereon and it is then kept in position.

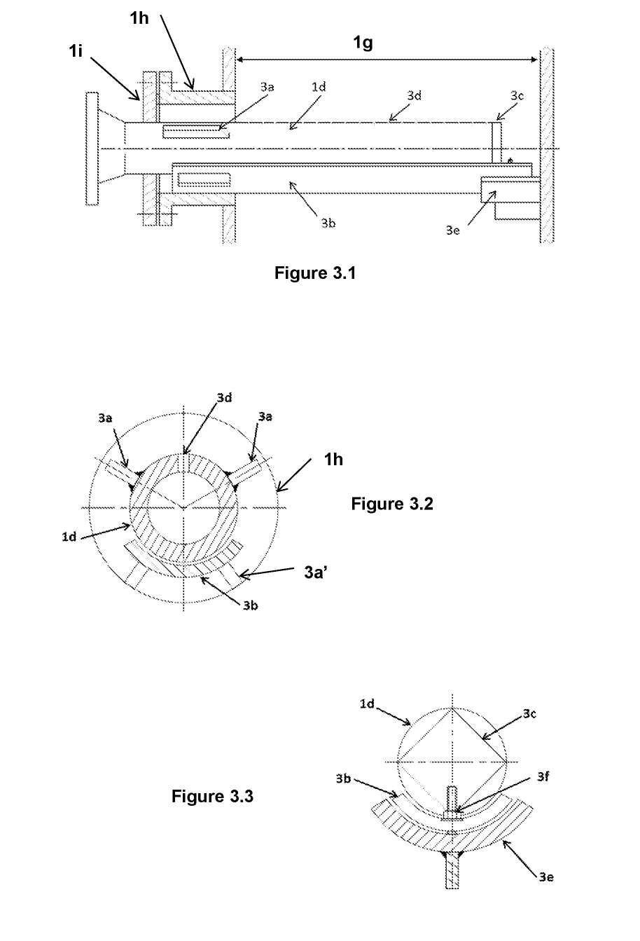

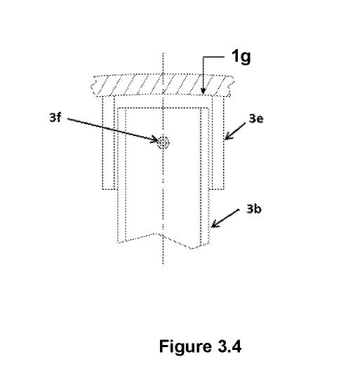

FIG. 3.1 shows an embodiment of the second variant implementation of the invention, comprising a distributor 1d in form of a tube provided with perforations 3d, support means in form of a gutter 3b and a gutter support 3e, guide means in form of fins 3a and a removable square head end cap 3c. FIGS. 3.3 and 3.4 detail more particularly the possible fastening of this gutter onto a fixing point on the wall of reaction vessel 1g. According to this design, perforations 3d of the distributor tube are also spaced out, directed upwards and distributed along a single line. Besides, according to this particular design of the invention, the gutter support is T-shaped, welded onto the wall of reaction vessel 1g, and it is provided with a threaded rod used for fixing the gutter, itself pierced, fixing of the gutter being completed by a screw-bolt connection 3f on the threaded rod. According to this design of the invention, the tube is provided with two fins 3a arranged on the part of the tube located within inlet pipe 1h when the distributor is operating. According to this design of the invention, and as shown in FIG. 3.2, the gutter itself is provided with two fins 3a′ arranged on the part of the gutter located within inlet pipe 1h when the distributor is operating. The section of the assembly made up of the distributor tube plus the fins plus the gutter is smaller than the section of inlet pipe 1h of reaction vessel 1g. In combination with the removable fastening means according to the invention comprising here at least one seal flange 1i, the distributor can thus be inserted into and removed from the vessel through the reaction vessel inlet, for maintenance or cleaning purposes. This installation or removal of the distributor is achieved through sliding along the gutter, fins 3a and 3a′ contributing to the centering of the distributor along the final axis thereof.

1. A system for distributing a liquid and/or gas phase into a reaction vessel, the vessel comprising at least one inlet for an injection of the phase, wherein the system comprises:
a distributor for distributing the phase, comprising at least one tube, the tube including a plurality of perforations,
means for removable fastening of the distributor when it is arranged in inlet of the vessel,
and in that the section of at least the distributor is smaller than the section of inlet.

2. A system as claimed in claim 1, wherein the removable fastening means consist of an assembly for reversibly securing at least one of the ends of the distributor to the inlet of the vessel.

3. A system as clamed in claim 2, wherein the assembly comprises at least one flange, a seal and at least one screwed joint.

4. A system as claimed in claim 1, wherein the system further comprises means for supporting the distributor at least at one point of the vessel opposite the inlet of the vessel.

5. A system as claimed in claim 4, wherein the support means comprise a rail intended to be fastened along the tube of the distributor, two plates intended to be fastened vertically onto a wall of the vessel so as to receive and hold the rail, the section of the assembly made up of at least the distributor and the rail being smaller than the section of the inlet of the vessel.

6. A system as claimed in claim 4, wherein the support means comprise a gutter and a support for the gutter, the gutter and the support being intended to be secured to the reaction vessel so as to allow the distributor to slide and to be kept in line with the inlet.

7. A system as claimed in claim 4, wherein the support means comprise a circular arc-shaped part intended to be fastened to the wall of the reaction vessel and to allow the distributor to be kept in line with the inlet.

8. A system as claimed in claim 1, wherein the system further comprises means for guiding the distributor upon its insertion into and/or removal from the vessel, the section of the assembly made up of at least said distributor and the guide means arranged on the distributor being smaller than the section of inlet of the vessel.

9. A system as claimed in claim 8, wherein the guide means comprise a plurality of fins distributed in a longitudinal direction over the tube of the distributor so as to provide centering of the distributor upon its insertion into and/or removal from inlet of the vessel.

10. A system as claimed in claim 1, wherein the system comprises means for installing the distributor in the vessel, the installation means being intended to be arranged outside the vessel.

11. A system as claimed in claim 10, wherein the means for installing the distributor comprise a movable platform whose deck is at the height of the inlet of the vessel.

12. A system as claimed in claim 10, wherein the installation means comprise a rail, a pulley system and a counterweight.

13. A reaction vessel comprising at least one system for distribution of a liquid and/or gas phase as claimed in claim 1.

14. Use of a reaction vessel comprising at least one system for distribution of a liquid and/or gas phase as claimed in claim 1 for a petroleum refining process.

15. Use as claimed in claim 14, wherein the refining process is a limited polymerization process.

16. A petroleum refining process comprising distributing a liquid and/or gas phase into a reaction vessel using at least one system for distribution of a liquid and/or gas phase as claimed in claim 1.

17. A limited polymerization process comprising distributing a liquid and/or gas phase into a reaction vessel using at least one system for distribution of a liquid and/or gas phase as claimed in claim 1.
